(19) United States
(12) Patent Application Publication
(10) Pub. No.: US 2020/0093312 A1
(43) Pub. Date: Mar. 26, 2020

(54) LINEAR SENSOR FOR REDUCTION COOKING AND BOIL DETECTION

(71) Applicant: Electrolux Home Products, Inc., Charlotte, NC (US)

(72) Inventors: Paul Stoufer, Lincolnton, NC (US); Stephen Smith, Concord, NC (US); John Taylor, Cornelius, NC (US)

(21) Appl. No.: 16/142,912

(22) Filed: Sep. 26, 2018

(51) Int. Cl. A47J 27/62; F24C 3/12; G05D 23/275

(52) U.S. Cl. CPC A47J 27/62; G05D 23/27543; F24C 3/126

(57) ABSTRACT

A system includes at least a computing apparatus including a communication interface coupled or coupleable to a sensor in contact with a heatable liquid contained in a vessel, the sensor being configured to obtain measurements of a property of the liquid or the sensor; and a processor coupled to the communication interface and configured to receive the measurements of the property of the liquid or the sensor. The processor is programmed to at least determine a height of the liquid in the vessel, and in at least one instance oscillation of the height of the liquid in the vessel, from the measurements, determine an amplitude of the oscillation, determine a level of boil of the liquid from the amplitude of the oscillation and a viscosity of the liquid, and output an indication of the level of boil for display or control of the heat to which the liquid is subjected.

### BACKGROUND

### Field of the Disclosure

Aspects of the disclosure relate to sensors and, more particularly, to a linear sensor for reduction cooking and boil detection.

### Description of Related Art

Modern home appliances include appropriate components that provide for control and/or operation thereof. In recent years, advancements and continued developments in sensor technology, encoder technology, and/or processing technology have enabled the implementation of sophisticated control units and/or controllers for home appliances. Various operational components of a home appliance are manually controllable via a control unit and/or controller in response to various user commands or selections initiated through a control element.

However, such home appliances may not include operational components that are automatically controllable in response to operating conditions. For example, where the home appliance is a cooktop having one or more controllable burners, a gas valve or radiant element may not be controllable via a control unit and/or controller in response to operating conditions (e.g., boil) occurring in a cooking vessel on the cooktop. In this example, a control unit and/or a controller may not be configured to automatically detect a height of liquid in the cooking vessel and/or an instance of oscillation of the height of the liquid in order to detect an impending boil-over condition in the cooking vessel. Thus, it would be desirable to provide a linear sensor that is coupleable with a communication interface and a processor to control and/or manage an operational component of a home appliance in response to a detected operating condition. Specifically, it would be advantageous to detect the operating condition, alert a user, and/or control/manage the home appliance in response thereto in order to advantageously provide improved usability and user-friendliness when using the home appliance.

### SUMMARY

Example implementations of the present disclosure provide systems and methods for detecting an impending boil-over condition (and/or other conditions/statuses) in a cooking vessel on a cooktop, alerting a user and/or taking corrective action to turn off the cooktop to avoid spillage and cleanup. The present disclosure includes, without limitation, the following example implementations:

### Example Implementation 1

A system comprising at least a computing apparatus that comprises a communication interface coupled or coupleable to a sensor in contact with liquid contained in a vessel in which the liquid is subjected to heat, the sensor being configured to obtain measurements of a property of the liquid or the sensor; and a processor coupled to the communication interface and configured to receive the measurements of the property of the liquid or the sensor, the processor being programmed to at least determine a height of the liquid in the vessel, and in at least one instance oscillation of the height of the liquid in the vessel, from the measurements; determine an amplitude of the oscillation; determine a level of boil of the liquid from the amplitude of the oscillation and a viscosity of the liquid; and output an indication of the level of boil for display or control of the heat to which the liquid is subjected.

### Example Implementation 2

The system of any preceding example implementation, or any combination of any preceding example implementations, further comprising the sensor, in which the sensor comprises a pair of spaced-apart, parallel tines in contact with the liquid and configured to obtain measurements of the property of the liquid.

### Example Implementation 3

The system of any preceding example implementation, or any combination of any preceding example implementations, in which a first tine of the pair of spaced-apart, parallel tines comprises a plurality of capacitive sensors spaced apart along a length thereof and configured to obtain measurements of capacitance in response to a voltage applied thereto, and a second tine of the pair of spaced-apart, parallel tines is a ground.

### Example Implementation 4

The system of any preceding example implementation, or any combination of any preceding example implementations, in which the pair of spaced-apart, parallel tines are parallel conducting tines configured to obtain measurements of capacitance in response to a voltage applied thereto.

### Example Implementation 5

The system of any preceding example implementation, or any combination of any preceding example implementations, in which a first tine of the pair of spaced-apart, parallel tines comprises a plurality of temperature sensors spaced apart along a length thereof and configured to obtain measurements of a temperature of the liquid at varying depths of the liquid in the vessel, and a second tine of the pair of spaced-apart, parallel tines is a ground.

### Example Implementation 6

The system of any preceding example implementation, or any combination of any preceding example implementations, in which the pair of spaced-apart, parallel tines form a vibrational viscometer configured to obtain measurements of the viscosity of the liquid.

### Example Implementation 7

The system of any preceding example implementation, or any combination of any preceding example implementations, further comprising the sensor, in which the sensor is a magnetostrictive sensor including an outer housing containing a coil of magnetostrictive material surrounding a magnetic flotation material that is configured to float on a surface of the liquid and function as a level transmitter to obtain measurements of a position of the magnetostrictive sensor in the liquid.

### Example Implementation 8

The system of any preceding example implementation, or any combination of any preceding example implementations, in which the processor being programmed to at least determine the level of boil of the liquid includes the processor being programmed to determine a speed of air bubble rise and burst at a surface of the liquid in the vessel from the amplitude of the oscillation and the viscosity of the liquid.

### Example Implementation 9

The system of any preceding example implementation, or any combination of any preceding example implementations, in which the processor is programmed to output the indication of the level of boil for control of the heat to a network interface unit of a cooktop, the network interface unit being configured to control the cooktop to control the heat to which the liquid is subjected.

### Example Implementation 10

A method comprising obtaining, by a sensor in contact with liquid contained in a vessel in which the liquid is subjected to heat, measurements of a property of the liquid or the sensor; and by a processor of a computing apparatus coupled with the sensor, determining a height of the liquid in the vessel, and in at least one instance oscillation of the height of the liquid in the vessel, from the measurements; determining an amplitude of the oscillation; determining a level of boil of the liquid from the amplitude of the oscillation and a viscosity of the liquid; and outputting an indication of the level of boil for display or control of the heat to which the liquid is subjected.

### Example Implementation 11

The method of any preceding example implementation, or any combination of any preceding example implementations, in which the sensor comprises a pair of spaced-apart, parallel tines in contact with the liquid, and obtaining the measurements of the property of the liquid or the sensor comprises obtaining the measurements of the property of the liquid using the pair of spaced-apart, parallel tines.

### Example Implementation 12

The method of any preceding example implementation, or any combination of any preceding example implementations, in which the pair of spaced-apart parallel tines comprises a first tine of the pair of spaced-apart, parallel tines including a plurality of capacitive sensors spaced apart along a length thereof and a second tine of the pair of spaced-apart, parallel tines being a ground, and obtaining the measurements of the property of the liquid using the pair of spaced-apart, parallel tines comprises obtaining measurements of capacitance in response to a voltage applied to the plurality of capacitive sensors on the first tine.

### Example Implementation 13

The method of any preceding example implementation, or any combination of any preceding example implementations, in which the pair of spaced-apart parallel tines comprises a pair of spaced-apart, parallel conducting tines, and obtaining the measurements of the property of the liquid using the pair of spaced-apart, parallel tines comprises obtaining measurements of capacitance in response to a voltage applied to the conducting tines.

### Example Implementation 14

The method of any preceding example implementation, or any combination of any preceding example implementations, in which the pair of spaced-apart parallel tines comprises a first tine of the pair of spaced-apart, parallel tines including a plurality of temperature sensors spaced apart along a length thereof and a second tine of the pair of spaced-apart, parallel tines being a ground, and obtaining the measurements of the property of the liquid using the pair of spaced-apart, parallel tines comprises obtaining measurements of a temperature of the liquid at varying depths of the liquid in the vessel.

### Example Implementation 15

The method of any preceding example implementation, or any combination of any preceding example implementations, in which the pair of spaced-apart parallel tines comprises a vibrational viscometer, and obtaining the measurements of the property of the liquid using the pair of spaced-apart, parallel tines comprises obtaining measurements of the viscosity of the liquid.

### Example Implementation 16

The method of any preceding example implementation, or any combination of any preceding example implementations, in which the sensor comprises a magnetostrictive sensor including an outer housing containing a coil of magnetostrictive material surrounding a magnetic flotation material that is configured to float on a surface of the liquid and function as a level transmitter, and obtaining the measurements of the property of the liquid using the pair of spaced-apart, parallel tines comprises obtaining measurements of a position of the magnetostrictive sensor in the liquid.

### Example Implementation 17

The method of any preceding example implementation, or any combination of any preceding example implementations, in which receiving the measurements of the property of the liquid or of the sensor by the processor includes the processor being programmed to determine a speed of air bubble rise and burst at a surface of the liquid in the vessel from the amplitude of the oscillation and the viscosity of the liquid.

### Example Implementation 18

The method of any preceding example implementation, or any combination of any preceding example implementations, in which the method further comprises outputting the indication of the level of boil for control of the heat to a network interface unit of a cooktop, the network interface unit being configured to control the cooktop to control the heat to which the liquid is subjected.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure, regardless of whether such features or elements are expressly combined or otherwise recited in a specific embodiment description herein. This disclosure is intended to be read holistically such that any separable features or elements of the disclosure, in any of its aspects and embodiments, should be viewed as combinable, unless the context of the disclosure clearly dictates otherwise.

It will therefore be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

Having thus described example implementations of the disclosure in general terms, reference will now be made to the accompanying drawings, which are not necessarily drawn to scale, and wherein:

FIG. 1 illustrates a system according to one example implementation of the present disclosure;

FIG. 2 illustrates an apparatus according to one example implementation of the present disclosure;

FIG. 3A illustrates a first implementation of a sensor according to one example implementation of the present disclosure;

FIG. 3B illustrates a second implementation of a sensor according to one example implementation of the present disclosure;

FIG. 4 illustrates a third implementation of a sensor according to one example implementation of the present disclosure;

FIG. 5A illustrates a flow chart of one example implementation of the present disclosure;

FIG. 5B illustrates a flow chart of another example implementation of the present disclosure; and

FIG. 6 illustrates a method according to one example implementation of the present disclosure.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. For example, unless otherwise indicated, reference something as being a first, second or the like should not be construed to imply a particular order. Like reference numerals refer to like elements throughout.

Example implementations of the present disclosure relate generally to sensors and, in particular, to a linear sensor for reduction cooking and boil detection. Example implementations may be useful for detecting impending boil-over conditions (and/or other conditions) in a cooking vessel on a cooktop, alerting a user and/or taking corrective action to turn off the cooktop to avoid spillage and cleanup. Other exemplary implementations may be useful for other applications, such as detecting impending boil-over conditions in cooking vessels in an oven, alerting a user and/or taking correction action to turn off the oven. It should be understood, however, that the sensor described herein may be modified in any number of ways to detect a specific operating condition occurring in a connected home appliance and otherwise control the connected home appliance in response to the detected operating condition. As described herein, examples of suitable network-connected systems include appliances such as dishwashers, washing machines, clothes dryers, refrigerators, freezers, ovens, ranges, cooktops, microwave ovens, trash compactors, air conditioners, water heaters or the like. It should be understood, however, that any of a number of other network-connected systems may equally benefit from example implementations of the present disclosure.

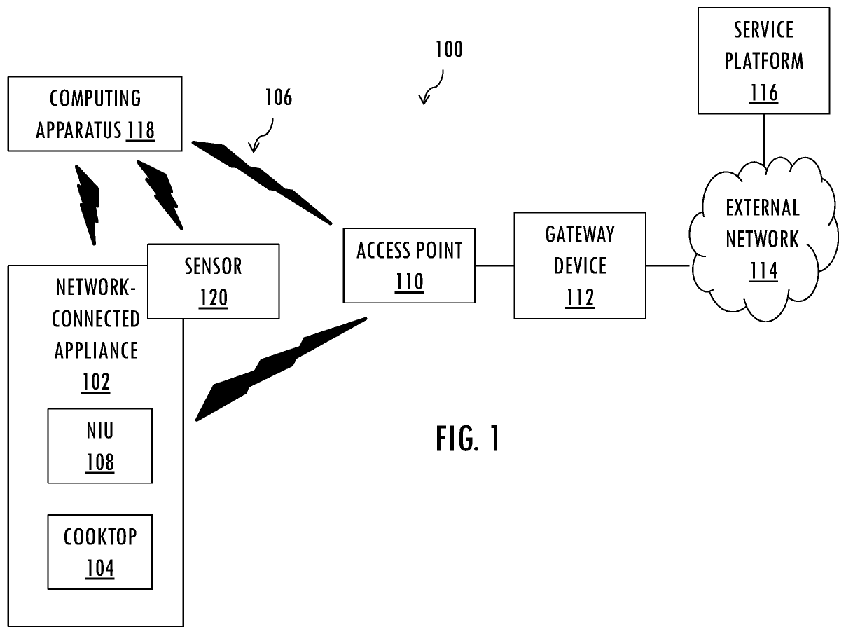

FIG. 1 illustrates a system 100 for detecting impending boil-over conditions in a cooking vessel being heated by an operational component of an appliance 102, alerting a user, and/or taking corrective action to turn off the operational component to avoid spillage and cleanup, according to various example implementations of the present disclosure. In some aspects, the operational component is a cooktop 104, which may be a gas, an electric, an induction, and/or any other type of cooktop capable of providing built-in surface heating to cooking vessels. According to example implementations, the appliance may be provisioned for connectivity to a packet-switched computer network such as a local area network (LAN) 106. In some examples, the appliance may include a network interface unit (NIU) 108, which may be integral with or otherwise directly connected to the appliance to enable its network connectivity.

As described herein, the LAN 106 may be a wireless LAN (WLAN) such as a WLAN implementing one or more IEEE 802.11 standards. It should be understood, however, that the LAN may additionally include or alternatively be a wired LAN such as a wired LAN implementing one or more IEEE 802.3 standards. Thus although the LAN may at times be simply referred to as a WLAN, the LAN may additionally include or alternatively be a wired LAN. Also at times, the appliance 102 may be referred to as a network-connected appliance.

The WLAN 106 may include appropriate networking hardware, some of which may be integral and others of which may be separate and interconnected. The WLAN may include a wireless access point 110 configured to permit wireless devices including the appliance 102 to connect to the WLAN. As also shown, for example, the WLAN may include a gateway device such as a residential gateway configured to connect the WLAN to an external packet-switched computer network 114 such as a wide area network (WAN) like the Internet. In some examples, the wireless access point or gateway device may include an integrated router to which other systems or devices may be connected. For example, the appliance 102 may comprise a wireless bridge (e.g., BLUETOOTH LE bridge) coupled to the NIU 108, which allows operational components (e.g., the cooktop 104) of the appliance 102 to be controllable through connectivity with other devices through the WLAN. The WLAN may also include other integral or separate and connected networking hardware, such as a network switch, hub, digital subscriber line (DSL) modem, cable modem or the like.

In some examples, the system 100 may further include a service platform 116, which may be embodied as a computer system accessible by the WLAN 106 or the external network 114. The service platform may include one or more servers, such as may be provided by one or more blade servers, a cloud computing infrastructure or the like. In some examples, the service platform may be embodied as a distributed computing system including multiple computing devices, such as may be used to provide a cloud computing infrastructure. And in these examples, the computing devices that form the service platform may be in communication with each other via a network such as the external network.

A computing apparatus 118 may be embodied as any computing apparatus configured to access the WLAN 106. By way of non-limiting example, the computing apparatus may be embodied as a personal computer (e.g., desktop computer, laptop computer), a mobile computing device (e.g., smart phone, tablet computer, digital camera) or the like. The computing apparatus may be configured to use any of a variety of wired or wireless (shown) network access technologies to access the WLAN. In some example implementations, the computing apparatus may include interfaces, which may include or otherwise provide an installed application or other interface through which the service platform 116 may be accessible. This application or other interface may be or may be provided by a thin client and/or other client application, such as a web browser application through which a web page (e.g., service portal) provided by the service platform may be accessible. As another example, the application or other interface may be or may be provided by a dedicated application, such as a mobile app installed on the computing apparatus embodied as a mobile computing device.

In some examples, a user of the computing apparatus 118 may access the service platform 116 and register an account with the service platform. This may include setup of a unique identifier of the user account, such as a unique user name, email address or other identifier, as well as identification (e.g., name) and perhaps location information for the user and/or their network-connected appliance 102. In some examples, a user that has registered an account with the service platform may download an application to the computing apparatus through which the user may interact with the service platform, such as to manage the appliance via the computing apparatus. A user may log-in to access their account with the service platform via the application and perform management and/or control functions from the computing apparatus. Additionally or alternatively, for example, the application may enable the computing apparatus to recognize and communicate with the appliance directly over the WLAN 106 without going through the service platform.

Once the user has registered an account, the user may associate (e.g., register) the appliance 102 that is owned by or otherwise associated with the user to the user's account with the service platform 116, which may enable user management and/or control of the appliance via the service platform. This may include, for example, establishing an association between the user account and a unique identifier of the appliance, such as a serial number, media access control (MAC) address, part number or other identifier. The association between the user account and identifier of the appliance may be maintained by the service platform to enable it to recognize and communicate with the appliance associated with a given user account. Additionally, the user may be able to receive alerts regarding a status of the appliance.

In some examples, the appliance 102 may be additionally or alternatively provisioned with an identifier having a predefined association with the user account. This identifier may be known to the service platform 116, and when presented to the service platform by the network-connected appliance, the service platform may recognize that the network-connected appliance is associated with the user account with which the identifier is associated. The appliance of these examples may communicate with the service platform via the WLAN 106 and external network 114, and present the identifier to indicate the user account with which the appliance is associated.

In some more particular examples, a user may select via an application on the computing apparatus 118 or via the service platform 116 to establish a new association between the appliance 102 and the user's account. In response, the service platform may generate a virtual serial number (VSN) associated with the user's account, and provision the VSN to the computing apparatus. In turn, the computing apparatus may provision the VSN to the appliance, such as via the WLAN 106. The appliance may store the VSN and present it back to the service platform to establish the association between the appliance and the user's account.

In some other examples, the computing apparatus 118 may be configured to provision their user-account identifier (e.g., user name, email address) to the appliance 102. Similar to before, the appliance may store the user-account identifier and present it to the service platform 116 to establish the association between the association between the appliance and the user's account. Further examples of suitable manners by which the computing apparatus may provision an identifier to a network-connected appliance to enable establishment of an association between the network-connected appliance and a user account are provided in PCT Patent Application No. PCT/US2014/070560, entitled: System, Method, Apparatus, and Computer Program Product for Configuring a Network Connected Appliance to Use Online Services, filed Dec. 16, 2014, the content of which is incorporated by reference in its entirety. As also further described in the '560 application, in some examples, the system 100 may further include one or more home automation systems connected to the WLAN and/or external network, and with which the network-connected appliance may be configured to operate.

The computing apparatus 118 is, in some example implementations of the present disclosure, configured to interface with a sensor 120 in contact with liquid contained in a cooking vessel. When the cooking vessel is subjected to heat from the cooktop 104, the sensor is configured to measure a property of the liquid or of the sensor, itself, as the liquid is heated. Properties of the liquid may include, but are not limited to, a height of the liquid or liquid level height (mm), a liquid viscosity (centipoise), an oscillation level (+/−mm), an oscillation speed (+/−mm/sec), a boil level (mm), and/or a height velocity (+/−mm/sec). Other properties of the liquid are also configured to be measured by the sensor. Properties of the sensor may include, but are not limited to, a position of the sensor in the liquid, atmospheric pressure.

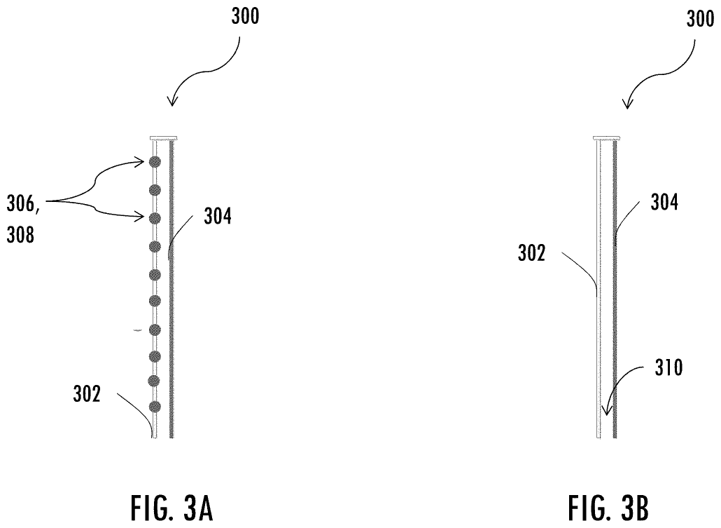

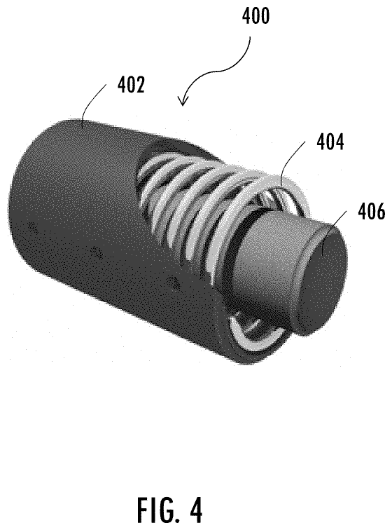

The sensor 120 may then transmit those measurements to the computing apparatus 118. To do so, the sensor may include a wireless transceiver (e.g., BLUETOOTH Low Energy) configured to transmit signals to and receive transmitted signals from the computing apparatus over the WLAN 106 or external network 114. The sensor is described in more detail below, in reference to FIGS. 3A, 3B, and 4.

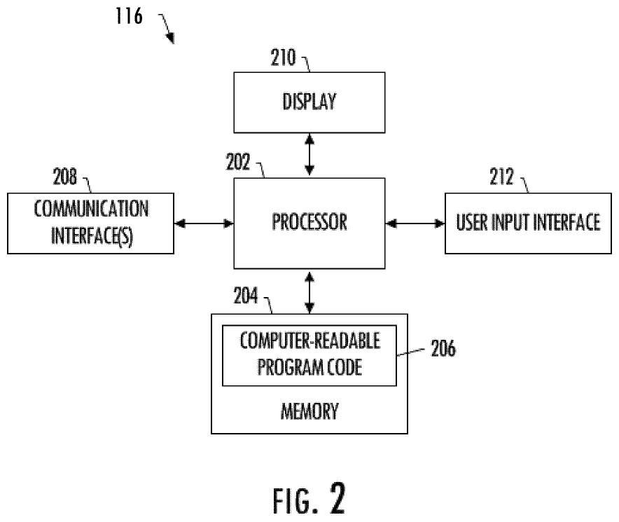

FIG. 2 more particularly illustrates the computing apparatus 118 according to some example implementations of the present disclosure. As shown, the computing apparatus may include one or more of each of a number of components such as, for example, a processor 202 connected to a memory 204. The processor is also connected to interfaces such as a communications interface 208 and/or one or more user interfaces such as a display 210 and/or user input interface 212. In some example implementations, the communication interface 208 is coupled or coupleable with the sensor 120 in contact with liquid contained in the cooking vessel. FIGS. 3A, 3B and 4 each illustrate various embodiments of a sensor configured to obtain measurements of properties of the liquid and/or the sensor. Notably, each of FIGS. 3A, 3B and 4 are merely exemplary and in no way are limiting to the manner in which measurements may be obtained or the configuration of the sensor.

FIGS. 3A, 3B illustrate a sensor 300 comprising a pair of spaced-apart, parallel tines 302, 304. The sensor is configured such that the pair of spaced-apart, parallel tines is in contact with liquid in a cooking vessel and is configured to obtain measurements of a property of the liquid from contact therewith. In some examples, the pair of spaced-apart, parallel tines is extendable based on a depth of the cooking vessel and/or an initial height of the liquid in the cooking vessel. In this example, the sensor is hung over the side of the cooking vessel (or otherwise provided in communication with the cooking vessel) and the pair of spaced-apart, parallel tines is extended until at least a portion of the tines are in contact with the liquid in the cooking vessel. While the pair of spaced-apart, parallel tines is in contact with the liquid, an electrical current may be established and transmitted to at least one of the spaced-apart, parallel tines.

In accordance with example implementations, in FIG. 3A, the first tine 302 of the pair of spaced-apart, parallel tines comprises a plurality of capacitive sensors 306 spaced apart along a length thereof. The capacitive sensors may be equidistantly spaced apart along a total length of the first tine. A second tine 304 of the pair of spaced-apart, parallel tines is a ground. An electrical current may be applied to the sensor 300 to produce an electric field between the spaced-apart, parallel tines. At edges of the spaced-apart, parallel tines, a ‘fringing’ effect may be produced. Fringe electric field lines affected by a height of the liquid in the cooking vessel may be obtained as a measurement of capacitance, using, for example the ‘parallel fingers’ approach. As such, the capacitive sensors are configured to obtain measurements of capacitance in response to a voltage applied thereto, such that a height of the liquid may be determined.

Alternatively, in FIG. 3A, the first tine 302 of the pair of spaced-apart, parallel tines comprises a plurality of temperature sensors 308 spaced apart along a length thereof. The temperature sensors may be equidistantly spaced apart along a total length of the first tine. The temperature sensors may comprise thermistors whose resistance is dependent on temperature. A second tine 304 of the pair of spaced-apart, parallel tines is a ground. An electrical current may be applied to the sensor 300. Thus, as the liquid in the cooking vessel is subjected to heat, the temperature sensors will change in resistance. As such, a change in resistance of each of the temperature sensors may be measured, such that a height of the liquid in the vessel and/or a level of boil of the liquid may be determined.

In FIG. 3B, the pair of spaced-apart, parallel tines 302, 304 are parallel conducting tines configured to obtain measurements of capacitance in response to a voltage applied thereto. The space between the spaced-apart, parallel tines is the dielectric region 310. Depending on a liquid level height, the dielectric region will affect the capacitance measurements. As such, when an electrical current is applied to one of the pair of the spaced-apart, parallel tines, a force may be exerted on the other of the pair of the spaced-apart, parallel tines thereby inducing opposite polarity charges. The capacitance is configured to be measured based on a ratio of positive or negative charge on each one of the pair of the spaced-apart, parallel tines to the voltage between them. As such, a height of the liquid may be calculated based on the measured capacitance.

Alternatively, in FIG. 3B, the pair of spaced-apart, parallel tines 302, 304 form a vibrational viscometer configured to obtain measurements of the viscosity of the liquid. More particularly, the viscosity of the liquid is measured by measuring the damping of the pair of spaced-apart, parallel tines that oscillate transversely in the liquid in the cooking vessel. An electrical current is applied to the pair of spaced-apart, parallel tines and the damping is measured by measuring power input necessary to keep the pair of spaced-apart, parallel tines vibrating at a constant amplitude, measuring a decay time of the oscillation once the electrical current is removed, or measuring a frequency as a function of phase angle between excitation and response waveforms. Alternatively, a speed of air bubble rise and collapse, and concave refill speed may be measured in order to obtain measurements of the viscosity of the liquid.

In some example implementations, the capacitive sensor in FIG. 3A or 3B may include a temperature sensor disposed on either one of the first or second tine of the pair of spaced-apart, parallel tines to determine a temperature of the liquid in the cooking vessel in addition to the capacitance. In some other example implementations, the capacitive sensor or the temperature sensor in FIG. 3A or 3B may include a pressure sensor disposed on either one of the first or second tine of the pair of spaced-apart, parallel tines to determine an atmospheric pressure in addition to the capacitance. Where a pressure sensor is included with the temperature sensor, the pressure sensor may be disposed towards a top portion of the first or second tine of the pair of spaced-apart, parallel tines so that it is not in contact with the liquid, whereas the temperature sensor may be disposed towards a bottom portion of the first or second tine of the pair of spaced-apart, parallel tines so that it is at or near the bottom of the cooking vessel when submersed.

FIG. 4 illustrates a magnetostrictive sensor 400 including an outer housing 402 containing a coil of magnetostrictive material 404 surrounding a magnetic flotation material 406. The magnetostrictive sensor is configured to float in liquid contained in a cooking vessel. Specifically, the magnetostrictive sensor is configured to float on a surface of the liquid and function as a level transmitter to obtain measurements of a position of the magnetostrictive sensor in the liquid. An electrical current may be established and transmitted to the magnetostrictive sensor, where pulses of current may be transmitted to the magnetostrictive sensor, thereby generating a circular magnetic field. The magnetic field may then magnetize the coil of magnetostrictive material axially. Since the two magnetic fields are superimposed, a torsion wave may be generated around the magnetic flotation material, which runs in both directions along the coil of magnetostrictive material. In this manner, one wave runs directly to the head of the outer housing, while the other is reflected at the bottom of the outer housing. Time may be measured between emission of the current pulse and arrival of the wave at the head of the outer housing. The position of the sensor and thereby the height of the liquid is determined on the basis of these transit times.

Other example implementations of a sensor (e.g., sensor 120, FIG. 1) may be used to measure other properties of the liquid or the sensor, such as an oscillation level by measuring a displacement of the surface of the liquid, an oscillation speed by measuring a speed of displacement of the surface of the liquid, a liquid viscosity by measuring the speed of bubble rise and collapse as well as the concave refill speed, a boil level by using surface displacement along with viscosity to normalize values to a known range (graduated boil desired), and/or a liquid level height velocity by measuring a speed of reference surface movement.

Returning back to FIG. 2, the sensor 120 may be configured to transmit the measurements of the property of the liquid or the sensor to the processor 202 coupled to the communication interface 208. The processor is programmed to receive the measurements of the property of the liquid or the sensor and is programmed with one or more functionalities to further process the received measurements using one or more system variables. The system variables may include measurements stored in the memory 204 associated with the processor or may be received at the processor via user input. The measurements may include preset measurement values, continuously updated measurement values, reference measurement values, and the like. The preset measurement values may be measurement values that are predetermined by user input or are predetermined by factory settings of the sensor. The preset measurement values may include a preset oscillation speed for different rates of oscillation (e.g., a hard boil, boil over, a soft boil, etc.), a preset liquid level height for different states of the liquid (e.g., reduction, simmer, scorch, etc.), a preset liquid viscosity for different liquid types (e.g., water, a thick sauce, a thin sauce, etc.). The continuously updated measurement values may be measurement values of a property of the liquid continuously updated during a period of time. The reference measurement values may be measurement values established at a beginning of the period of time, which establish an initial or reference value for the liquid or the sensor (e.g., an initial liquid level height, an initial temperature of the liquid in the vessel, an initial position of the sensor in the cooking vessel, etc.)

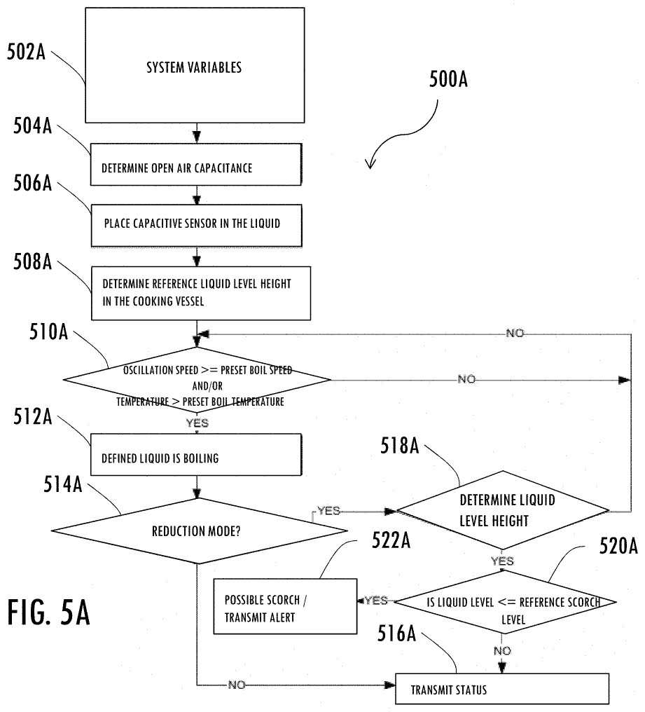

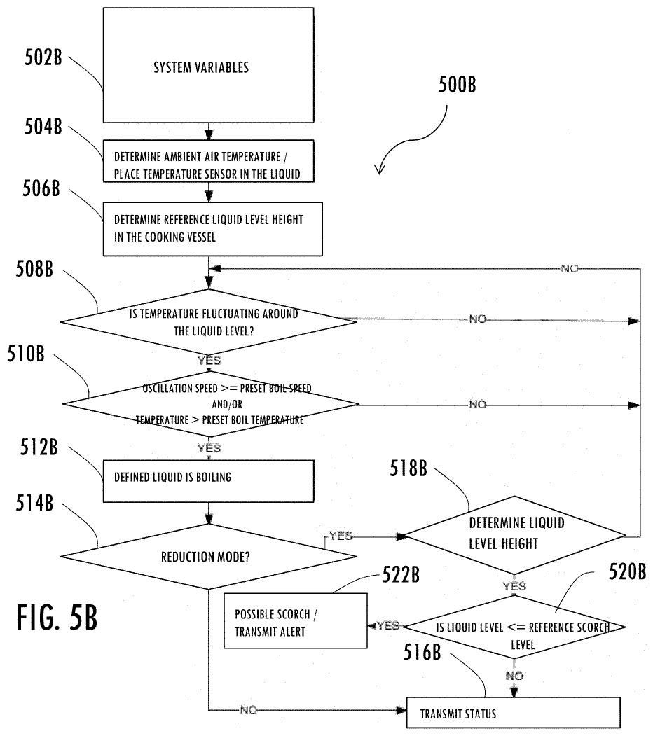

FIGS. 5A-5B each illustrate a flow chart of an example implementation of an algorithm for processing the measurements of the property of the liquid or the sensor (e.g., sensor 120, FIG. 1). FIG. 5A illustrates a flow chart of an example implementation of an algorithm using a capacitive sensor to detect boiling and/or scorch of a liquid in a cooking vessel, generally designated 500A. FIG. 5B illustrates a flow chart of an example implementation of an algorithm using a temperature sensor to detect boiling and/or scorch of liquid in a cooking vessel, generally designated 500B. However, these example implementations are in no way limiting and may be an illustrative of any iterative process disclosed herein. For example, the flow chart of the algorithm may also include additional and/or alternative system variables in order to measure a different state of the liquid (e.g., a simmer).

In FIG. 5A, at block 502A, the system variables may be stored in the memory 204 associated with the processor 202 or may be received at the processor via user input. As noted herein, the system variables may include preset measurement values, continuously updated measurement values, reference measurement values, and the like.

At block 504A, a capacitive sensor (such as, for example, a capacitive sensor as disclosed herein) is utilized to determine an open air capacitance, before the capacitive sensor is in contact with the liquid in the cooking vessel. The open air capacitance may be determined from an internal calibration or factory setting on the capacitive sensor, such that the open air capacitance may be a preset measurement value. The open air capacitance may be stored in the memory 204. Otherwise, the capacitive sensor may configured to measure the open air capacitance and transmit the measurement to the processor 202, which can store the open air capacitance in the memory.

At block 506A, the capacitive sensor may be brought into contact with the liquid. For example, and as described herein, the tine(s) of the capacitive sensor may be extended or the sensor may be otherwise placed into the liquid in the cooking vessel. A capacitance may be determined (“determined capacitance”) from the fringing effect occurring as a result of the capacitive sensor being placed in the liquid in the cooking vessel. The determined capacitance may be transmitted to the processor 202 and stored in the memory 204.

At block 508A, the processor 202 may be configured to access the stored open air capacitance and the determined capacitance in order to determine a reference value of the liquid level height in the cooking vessel (“reference liquid level height”) based on the difference between the open air capacitance and the determined capacitance.

Notably, the reference liquid level height may be continuously updated based on evaporation and/or air displacement. As the liquid is heated, the reference liquid level height will decrease due to evaporation. Air displacement will cause the reference liquid level height to increase. These changes in the reference liquid level height may be measured by the capacitive sensor as a determined capacitance and transmitted to the processor 202, such that the reference liquid level height determined by the processor may be adjusted continuously. In addition, the processor 202 may be configured to process the reference liquid level height to determine a depth of the cooking vessel. The depth of the cooking vessel may be used to determine a bottom surface of the cooking vessel, such that a reference measurement value for the scorch level “reference scorch level” may be determined by the processor. In particular, the reference scorch level may be determined by calculating a small percent value, or a fraction thereof, of the reference liquid level height.

At block 510A, the capacitive sensor may be configured to determine at least one instance of oscillation of the height of the liquid in the cooking vessel. Oscillation may be caused as the liquid begins to be heated and air bubbles form at the bottom of the liquid and rise to the surface of the liquid. As the air bubbles rise to the surface of the liquid (near the capacitive sensor) the height of the liquid may increase from the reference liquid level height and the surface of the liquid is convex. When the air bubbles burst on the surface, the height of the liquid quickly decreases from the reference liquid level height and the surface of the liquid is concave. An instance of oscillation may be determined when the capacitive sensor detects a variation from the reference liquid level height that is greater than about 0.5 mm.

From the at least one instance of oscillation of the height of the liquid in the cooking vessel received from the capacitive sensor, the processor 202 may be configured to access from the memory 204 the reference liquid level height to determine an amplitude of oscillation. The amplitude of the oscillation may be determined based on measurements of the plus and minus liquid height variations from the reference liquid level height that are measured by the capacitive sensor and transmitted to the processor. For example, the oscillation may be considered ‘light’ if the plus and minus liquid height variations from the reference liquid level height are small (e.g., 0.5 mm). The oscillation may be considered ‘strong’ if the plus and minus liquid height variations from the reference liquid level height are large (e.g., 10 mm). A very light oscillation may correlate to ‘simmer’ and a large rapid oscillation may correlate to a ‘hard boil.’ Minor changes in the reference liquid level height may be used only, as described above, to recalibrate the reference liquid level height and not to calculate the amplitude of the oscillation. Varying amplitudes of oscillation will produce a range of measured boiling. The amplitude of the oscillation may be continuously updated based on the updated measurements of the at least one instance of oscillation of the height of the liquid in the cooking vessel measured at specific time intervals during the time period. These time intervals may be defined by user input or may be previously specified.

The amplitude of oscillation may be further used by the processor 202 to determine an oscillation speed of the liquid in the cooking vessel. The oscillation speed is the speed at which the air bubbles rise and burst, which may be measured by the capacitive sensor and transmitted to the processor. The oscillation speed may then be stored in the memory 204. At each instance of updating the oscillation speed (based on an updated determination of the amplitude of oscillation), the processor is configured to access, from the memory, a preset measurement value of oscillation speed (“preset oscillation speed”) to determine if the oscillation speed based on an updated determination of the amplitude of oscillation is greater than or equal to the preset oscillation speed.

Additionally, or instead of, the capacitive sensor may be configured to measure a temperature (in ° F., ° C., or K) of the liquid in the cooking vessel and transmit the temperature to the processor 202 and store it in the memory 204. The temperature may be a continuously updated measurement that is measured at specific time intervals during the time period, which may be the same or a different time period than the time intervals during which the capacitance is determined. At each instance of receiving an updated temperature, the processor may be configured to access, from the memory, a preset measurement value of boil temperature (i.e., “preset boil temperature”) to determine if the updated temperature is greater than the preset boil temperature.

Otherwise, the processor 202 is configured to process whether the oscillation speed is greater than or equal to the preset oscillation speed or the temperature is greater than the preset boil temperature, based on updated capacitance or temperature measurements.

At block 512A, either the oscillation speed is greater than or equal to the preset oscillation speed or the temperature is greater than the preset boil temperature. The oscillation speed at which the air bubbles rise and burst may be used to determine the level of boil, which may be based on the amplitude of the oscillation and the viscosity of the liquid. Some liquids will have higher or lower viscosity and so will have faster or slower bubble rise and burst speeds. Notably, higher viscosity liquids will have slower surface motion than lower viscosity liquids at the same boil level. The viscosity for the liquid in the cooking vessel may be accessed by the processor from the memory as a preset measurement value “preset liquid viscosity.”

At block 514A, the capacitive sensor may be triggered to switch into a new mode. As noted herein, another mode or application may be utilized in the flow chart depending on the system variables. For example, a reduction mode may be used. The mode that the capacitive sensor switches into may then change the measurements that the capacitive sensor obtains during the period of time, as determined by user input or as preset.

At block 516A, if there is no additional mode after the boil detection mode, then the processor 202 is configured to output an indication to the computing apparatus 118 of the boil level for display or control of the heat to which the liquid is subjected. The computing apparatus may emit an alert regarding the status of the liquid in the cooking vessel as a result.

At block 518A, if there is an additional mode such as a reduction mode, then the processor 202 may be configured to determine an updated liquid level height based on updated measurements of the difference between the determined capacitance and the open air capacitance. The liquid level height may be transmitted to the processor and stored in the memory 204. The liquid level height may comprise a continuously updated determination of the difference between the determined capacitance and the open air capacitance, where the determined capacitance is measured at specific time intervals during the time period. These time intervals may be defined by user input or may be previously specified. At each instance of receiving an updated capacitance from the sensor, the processor may be configured to determine the liquid level height and then access, from the memory, a preset measurement value of reduction level (“preset reduction level” or a preset liquid level height for the reduction state of the liquid) to determine if the liquid level height based on the updated determined capacitance is equal to the preset reduction level. If not, then the flow chart returns to step 510A to continuously determine the oscillation speed of the liquid in the cooking vessel.

At block 520A, if the liquid level height is equal to the preset reduction level, then at each instance of receiving a determined capacitance from the sensor, the processor 202 may be configured to continuously update the liquid level height and then access, from the memory 204, the reference scorch level. Otherwise, for example, a preset measurement value of scorch level (“preset scorch level” or a preset, minimum liquid level height of the liquid in the cooking vessel in order to prevent scorch of the liquid in the cooking vessel) is used to determine if the liquid level height based on a determined capacitance is less than or equal to the reference scorch level. If the liquid level height is greater than the reference scorch level, then the processor is configured to output an indication to the computing apparatus 118 of the possibility of scorch of the cooking vessel should the cooking vessel remain on the network-connected appliance 102 at a current heat level or control of the heat to which the liquid is subjected, i.e., lower the heat on the network-connected appliance, at block 516A.

At block 522A, where the liquid level height is less than or equal to the reference scorch level, then the processor 202 may determine that the liquid level height in the cooking vessel is too low such that the cooking vessel may be scorched. As used herein, scorch is defined as the burning an interior surface of the cooking vessel with heat. If so, then the processor is configured to output an indication (e.g., “Possible Scorch Transmit Alert”) to the computing apparatus 118 of the possibility of scorch of the cooking vessel for display or control of the heat to which the liquid is subjected, i.e., turn off the network-connected appliance 102.

In FIG. 5B, at block 502B, the system variables may be stored in the memory 204 associated with the processor 202 or may be received at the processor via user input. As noted herein, the system variables may include preset measurement values, continuously updated measurement values, reference measurement values, and the like.

At block 504B, a temperature sensor (such as, for example, a temperature sensor disclosed herein) is utilized to determine a temperature of ambient air “ambient air temperature” (in ° F., ° C., or K). The ambient air temperature may be determined from an internal calibration or factory setting on the temperature sensor, such that the ambient air temperature may be a predetermined measurement value. The ambient air temperature may be stored in the memory 204. Otherwise, the temperature sensor may be able to measure the ambient air temperature and transmit the measurement to the processor 202, which can store the ambient air temperature in the memory.

The temperature sensor may also be configured to determine a temperature of the liquid in the cooking vessel. The temperature sensor may be brought into contact with the liquid. For example, and as described herein, the tine(s) of the temperature sensor may be extended or the temperature sensor may be otherwise placed into the liquid in the cooking vessel. Temperature(s) may be measured from a plurality of individual temperature sensors (e.g., thermistors) spaced apart along a length of a first or second tine of the temperature sensor, each thermistor being configured to measure a temperature of the liquid in the cooking vessel based on a location of the thermistor within the liquid. The measured temperature(s) may be transmitted to the processor 202 to determine a temperature at the surface of the liquid in the cooking vessel (“determined temperature”), the determined temperature and other measured temperature values at each temperature sensor being stored in the memory 204.

At block 506B, the processor 202 may be configured to access the stored ambient air temperature and the determined temperature in order to determine a reference value of the liquid level height based on the difference between the ambient air temperature and the determined temperature. The reference value may be stored in the memory 204.

Notably, the reference liquid level height may be continuously updated based on evaporation and/or air displacement. As the liquid is heated, the reference liquid level height will decrease due to evaporation. Air displacement will cause the reference liquid level height to increase. These changes in the reference liquid level height may be measured by the temperature sensor as a determined temperature and transmitted to the processor 202, such that the reference liquid level height determined by the processor may be adjusted continuously.

In addition, the processor 202 may be configured to process the reference liquid level height to determine a depth of the cooking vessel. The depth of the cooking vessel may be used to determine a bottom surface of the cooking vessel, such that a reference scorch level may be determined.

At block 508B, the processor 202 is configured to compare stored values of the liquid level height and corresponding temperatures of the liquid in the cooking vessel. In this way, the processor may be able to determine if the determined temperature (i.e., the temperature at the surface of the liquid) is fluctuating over a period of time. If not, then the processor continues to compare the updated stored values of the liquid level height and the corresponding temperatures of the liquid in the cooking vessel.

At block 510B, the temperature sensor may be configured to determine at least one instance of oscillation of the height of the liquid in the cooking vessel. An instance of oscillation may be determined when the temperature sensor detects a variation from the reference liquid level height that is greater than about 0.5 mm. From the at least one instance of oscillation of the height of the liquid in the cooking vessel received from the temperature sensor, the processor 202 may be configured to access from the memory 204 the reference liquid level height to determine an amplitude of oscillation. The amplitude of the oscillation may be determined based on measurements of the plus and minus liquid height variations from the reference liquid level height that are measured by the temperature sensor and transmitted to the processor. The amplitude of the oscillation may be a continuously updated determination based on the updated measurements of the instances of oscillation of the height of the liquid in the cooking vessel measured at specific time intervals during the time period. These time intervals may be defined by user input or may be previously specified.

The amplitude of oscillation may be further used by the processor 202 to determine an oscillation speed of the liquid in the cooking vessel. The oscillation speed may then be stored in the memory 204. At each instance of updating the oscillation speed (based on an updated determination of the amplitude of oscillation), the processor is configured to access, from the memory, the preset oscillation speed to determine if the oscillation speed based on an updated determination of the amplitude of oscillation is greater than or equal to the preset oscillation speed.

Additionally, or instead of, the processor 202 may be configured to access the determined temperature and the preset boil temperature from the memory 204 to determine if the updated determined temperature is greater than the preset boil temperature. Otherwise, the processor is configured to process whether the oscillation speed is greater than or equal to the preset oscillation speed or the determined temperature is greater than the preset boil temperature based on updated temperature measurements.

At block 512B, either the oscillation speed is greater than or equal to the preset oscillation speed or the temperature is greater than the preset boil temperature. As such, the processor 202 is configured to determine a level of boil of the liquid based on the oscillation speed and/or determine a viscosity of the liquid.

At block 514B, the temperature sensor may be triggered to switch into a new mode. As noted herein, another mode or application may be utilized in the flow chart depending on the system variables. For example, a reduction mode may be used. The mode that the temperature sensor switches into may then change the measurements that the temperature sensor obtains during the period of time, as determined by user input or as preset.

At block 516B, if there is no additional mode after a boil detection mode, then the processor 202 is configured to output an indication to the computing apparatus 118 of the boil level for display or control of the heat to which the liquid is subjected. The computing apparatus may emit an alert regarding the status of the liquid in the cooking vessel as a result.

At block 518B, if there is an additional mode such as a reduction mode, then the processor 202 may be configured to determine an updated liquid level height based on updated measurements of the difference between the determined temperature and the ambient air temperature. The liquid level height may be transmitted to the processor and stored in the memory 204. The liquid level height may comprise a continuously updated determination of the difference between the determined temperature and the ambient air temperature, where the determined temperature is measured at specific time intervals during the time period. These time intervals may be defined by user input or may be previously specified. At each instance of receiving an updated temperature from the sensor, the processor may be configured to determine the liquid level height and then access, from the memory, a preset reduction level to determine if the liquid level height based on updated determined temperature is equal to the preset reduction level. If not, then the flow chart returns to step 510B to continuously determine the oscillation speed of the liquid in the cooking vessel.

At block 520B, if the liquid level height is equal to the preset reduction level, then at each instance of receiving a determined temperature from the sensor, the processor 202 may be configured to continuously update the liquid level height and then access, from the memory 204, the reference scorch level. Otherwise, for example, a preset scorch level is used to determine if the liquid level height based on a determined temperature is less than or equal to the reference scorch level. If the liquid level height is greater than the reference scorch level, then the processor is configured to output an indication to the computing apparatus 118 of the possibility of scorch of the cooking vessel should the cooking vessel remain on the network-connected appliance 102 at a current heat level or control of the heat to which the liquid is subjected, i.e., lower the heat on the network-connected appliance, at block 516B.

At block 522B, where the liquid level height is less than or equal to the reference scorch level, then the processor 202 may determine that the liquid level height in the cooking vessel is too low such that the cooking vessel may be scorched. If so, then the processor is configured to output an indication (e.g., “Possible Scorch Transmit Alert”) to the computing apparatus 118 of the possibility of scorch of the cooking vessel for display or control of the heat to which the liquid is subjected, i.e., turn off the network-connected appliance 102.

Referring to either FIG. 5A or 5B, at blocks 516A or 516B, in some examples, the processor 202 is programmed to output an indication of the level of boil for display or control of the heat to which the liquid is subjected. More generally, the processor 202 may be programmed to output a status for the appliance 102 for display at the display 210. A user that has registered an account with the service platform and downloaded the application to the computing apparatus 118 may be able to receive an alert regarding a status of the appliance (e.g., appliance 102, FIG. 1). More particularly, a user may be able to input status update requests in the application using, for example, the user input interface 212. As such, after the user has executed the application, the processor may be programmed to output an indication of the status (e.g., level of boil) for display by the computing apparatus in order to alert the user that the liquid in the cooking vessel is boiling. Additionally, the processor of the computing apparatus may otherwise include functionality to alert the user when certain temperatures of the liquid in the cooking vessel have been reached, after the liquid in the cooking vessel achieves a desired viscosity, after the liquid in the cooking vessel has decreased from the reference height a desired amount (i.e., reduced), after the liquid is reduced a specified amount (“liquid level reduction target”), and the like. In this manner, after receiving the alert, the user may be able to manually adjust the heat that the liquid in the cooking vessel is subjected.

In additional or some alternative implementations, the processor 202 is programmed to output the indication of the level of boil for control of the heat to the NIU 108, the NIU being configured to receive the indication of the level of boil from the processor 202 and control the cooktop 104 to control the heat to which the liquid is subjected. The output from the processor may be in the form of a signal such as a closed loop control signal configured to continuously modulate and control the heat that the liquid is subjected to based off of the measured property(s) of the liquid and/or the sensor. Such closed loop control may include proportional-integral-derivative (PID) control logic, using a user-defined set-point and one or more system variables. In turn, the NIU may be configured to control the heat output by the operational component (e.g., the cooktop). For example, the processor may be programmed to output a signal to the NIU to reduce the burner heat to prevent boil-over based off of a measured oscillation height (e.g., a measured property of the liquid) and a desired level of boil (e.g., a user-defined set-point).

In view of the above and in accordance with example implementations of the present disclosure, the user may be able to use the user input interface 212 of the computing apparatus 118 to manage certain aspects of the appliance 102 in conjunction with automatic adjustment of the operational components (e.g., cooktop 104, FIG. 1) of the appliance 102. For example, the user may utilize the application on the computing apparatus to input or set a desired boil level on a graduated scale (e.g., 1 to 20), such that the processor 202 is configured to continuously monitor the oscillation and adjust the output to the NIU 108 in order to reach and maintain the requested boil level.

Additionally, in another example, the user may utilize the application on the computing apparatus 118 to set a liquid level reduction target based on the profile of the liquid in the cooking vessel. This may be desirable where the application is connected to or includes a database containing a profile of various liquids being heated (e.g., fats, proteins, sugars), a scald or burn reaction, etc., the profile of the liquid determining how much the liquid should be reduced. In this manner, the processor 202 is configured to adjust the output to the NIU 108 in order to reach the liquid level reduction target and prevent scalding or burning of the liquid.

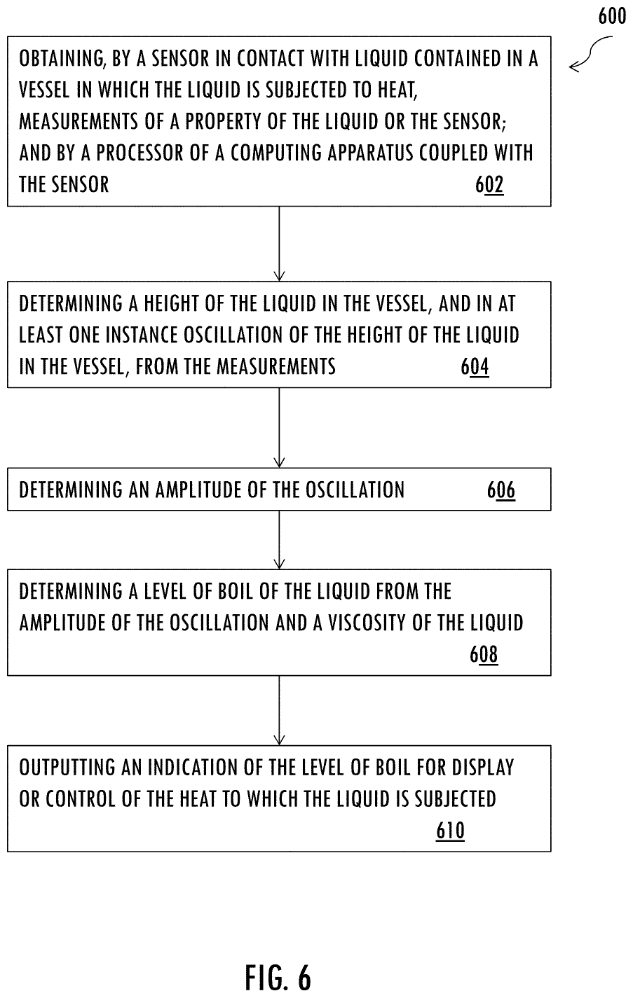

FIG. 6 is a flowchart illustrating various steps in a method 600 of detecting impending boil-over conditions in a cooking vessel on a cooktop, alerting a user and/or taking corrective action to turn off the cooktop to avoid spillage and cleanup, according to some example implementations of the present disclosure. As shown in 602, the method may include obtaining, by a sensor in contact with liquid contained in a vessel in which the liquid is subjected to heat, measurements of a property of the liquid or the sensor; and by a processor of a computing apparatus coupled with the sensor. The method may include determining a height of the liquid in the vessel, and in at least one instance oscillation of the height of the liquid in the vessel, from the measurements, as shown in block 604. The method may include determining an amplitude of the oscillation, as shown in block 606. The method may include determining a level of boil of the liquid from the amplitude of the oscillation and a viscosity of the liquid, as shown in block 608. The method may include outputting an indication of the level of boil for display or control of the heat to which the liquid is subjected, as shown in block 610.

Referring back to FIG. 2, again, the computing apparatus 118 according to some example implementations includes a processor 202, memory 204, communications interface 208, display 210 and/or user input interface 212. The processor is generally any piece of computer hardware that is capable of processing information such as, for example, data, computer-readable program code, instructions or the like (at times generally referred to as “computer programs,” e.g., software, firmware, etc.), and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory (of the same or another apparatus). In other examples, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory 204 is generally any piece of computer hardware that is capable of storing information such as, for example, data, computer programs (e.g., computer-readable program code 206) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive or the like. In various instances, the memory may be referred to as a computer-readable storage medium. The computer-readable storage medium is a non-transitory device capable of storing information, and is distinguishable from computer-readable transmission media such as electronic transitory signals capable of carrying information from one location to another. Computer-readable medium as described herein may generally refer to a computer-readable storage medium or computer-readable transmission medium.

The interfaces may include a communications interface 208 and/or one or more user interfaces. In some examples, particularly in instances in which the computing apparatus 118 is configured to implement an NIU (e.g., NIU 108, FIG. 1), the apparatus may not include a separate user interface, and may instead interact with one provided by the appliance. The communications interface may be configured to transmit and/or receive information, such as to and/or from other apparatus(es), network(s) or the like. The communications interface may be configured to transmit and/or receive information by physical (wired) and/or wireless communications links. Examples of suitable communication interfaces include a network interface controller (NIC), wireless NIC (WNIC) or the like.

The user interfaces may include a display 214) and/or one or more user input interfaces 212. The display may be configured to present or otherwise display information to a user, suitable examples of which include a liquid crystal display (LCD), light-emitting diode display (LED), plasma display panel (PDP) or the like. The user input interfaces may be wired or wireless, and may be configured to receive information from a user into the apparatus, such as for processing, storage and/or display. Suitable examples of user input interfaces include a microphone, image or video capture device, keyboard or keypad, mouse, joystick, touch-sensitive surface (e.g., touchpad, touchscreen), biometric sensor or the like.

As indicated above, program code instructions may be stored in memory, and executed by a processor, to implement functions described herein. As will be appreciated, any suitable program code instructions may be loaded onto a computer or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus.

Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. In this manner, an computing apparatus 118 may include a processor 202 and a computer-readable storage medium or memory 204 coupled to the processor, where the processor is configured to execute computer-readable program code 206 stored in the memory. It will also be understood that one or more functions, and combinations of functions, may be implemented by special purpose hardware-based computer systems and/or processors which perform the specified functions, or combinations of special purpose hardware and program code instructions.

Many modifications and other implementations of the disclosure set forth herein will come to mind to one skilled in the art to which these disclosure pertain having the benefit of the teachings presented in the foregoing descriptions and the associated drawings. Therefore, it is to be understood that the disclosure are not to be limited to the specific implementations disclosed and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising at least a computing apparatus that comprises:
a communication interface coupled or coupleable to a sensor in contact with liquid contained in a vessel in which the liquid is subjected to heat, the sensor being configured to obtain measurements of a property of the liquid or the sensor; and
a processor coupled to the communication interface and configured to receive the measurements of the property of the liquid or the sensor, the processor being programmed to at least:
determine a height of the liquid in the vessel, and in at least one instance oscillation of the height of the liquid in the vessel, from the measurements;
determine an amplitude of the oscillation;
determine a level of boil of the liquid from the amplitude of the oscillation and a viscosity of the liquid; and
output an indication of the level of boil for display or control of the heat to which the liquid is subjected.

2. The system of claim 1 further comprising the sensor, wherein the sensor comprises a pair of spaced-apart, parallel tines in contact with the liquid and configured to obtain measurements of the property of the liquid.

3. The system of claim 2, wherein a first tine of the pair of spaced-apart, parallel tines comprises a plurality of capacitive sensors spaced apart along a length thereof and configured to obtain measurements of capacitance in response to a voltage applied thereto, and a second tine of the pair of spaced-apart, parallel tines is a ground.

4. The system of claim 2, wherein the pair of spaced-apart, parallel tines are parallel conducting tines configured to obtain measurements of capacitance in response to a voltage applied thereto.

5. The system of claim 2, wherein a first tine of the pair of spaced-apart, parallel tines comprises a plurality of temperature sensors spaced apart along a length thereof and configured to obtain measurements of a temperature of the liquid at varying depths of the liquid in the vessel, and a second tine of the pair of spaced-apart, parallel tines is a ground.

6. The system of claim 2, wherein the pair of spaced-apart, parallel tines form a vibrational viscometer configured to obtain measurements of the viscosity of the liquid.

7. The system of claim 1 further comprising the sensor, wherein the sensor is a magnetostrictive sensor including an outer housing containing a coil of magnetostrictive material surrounding a magnetic flotation material that is configured to float on a surface of the liquid and function as a level transmitter to obtain measurements of a position of the magnetostrictive sensor in the liquid.

8. The system of claim 1, wherein the processor being programmed to at least determine the level of boil of the liquid includes the processor being programmed to determine a speed of air bubble rise and burst at a surface of the liquid in the vessel from the amplitude of the oscillation and the viscosity of the liquid.

9. The system of claim 1, wherein the processor is programmed to output the indication of the level of boil for control of the heat to a network interface unit of a cooktop, the network interface unit being configured to control the cooktop to control the heat to which the liquid is subjected.

10. A method comprising:
obtaining, by a sensor in contact with liquid contained in a vessel in which the liquid is subjected to heat, measurements of a property of the liquid or the sensor; and by a processor of a computing apparatus coupled with the sensor,
determining a height of the liquid in the vessel, and in at least one instance oscillation of the height of the liquid in the vessel, from the measurements;
determining an amplitude of the oscillation;
determining a level of boil of the liquid from the amplitude of the oscillation and a viscosity of the liquid; and
outputting an indication of the level of boil for display or control of the heat to which the liquid is subjected.

11. The method of claim 10, wherein the sensor comprises a pair of spaced-apart, parallel tines in contact with the liquid, and obtaining the measurements of the property of the liquid or the sensor comprises obtaining the measurements of the property of the liquid using the pair of spaced-apart, parallel tines.

12. The method of claim 11, wherein the pair of spaced-apart parallel tines comprises a first tine of the pair of spaced-apart, parallel tines including a plurality of capacitive sensors spaced apart along a length thereof and a second tine of the pair of spaced-apart, parallel tines being a ground, and obtaining the measurements of the property of the liquid using the pair of spaced-apart, parallel tines comprises obtaining measurements of capacitance in response to a voltage applied to the plurality of capacitive sensors on the first tine.

13. The method of claim 11, wherein the pair of spaced-apart parallel tines comprises a pair of spaced-apart, parallel conducting tines, and obtaining the measurements of the property of the liquid using the pair of spaced-apart, parallel tines comprises obtaining measurements of capacitance in response to a voltage applied to the conducting tines.

14. The method of claim 11, wherein the pair of spaced-apart parallel tines comprises a first tine of the pair of spaced-apart, parallel tines including a plurality of temperature sensors spaced apart along a length thereof and a second tine of the pair of spaced-apart, parallel tines being a ground, and obtaining the measurements of the property of the liquid using the pair of spaced-apart, parallel tines comprises obtaining measurements of a temperature of the liquid at varying depths of the liquid in the vessel.

15. The method of claim 11, wherein the pair of spaced-apart parallel tines comprises a vibrational viscometer, and obtaining the measurements of the property of the liquid using the pair of spaced-apart, parallel tines comprises obtaining measurements of the viscosity of the liquid.

16. The method of claim 10, wherein the sensor comprises a magnetostrictive sensor including an outer housing containing a coil of magnetostrictive material surrounding a magnetic flotation material that is configured to float on a surface of the liquid and function as a level transmitter, and obtaining the measurements of the property of the liquid using the pair of spaced-apart, parallel tines comprises obtaining measurements of a position of the magnetostrictive sensor in the liquid.

17. The method of claim 10, wherein receiving the measurements of the property of the liquid or of the sensor by the processor includes the processor being programmed to determine a speed of air bubble rise and burst at a surface of the liquid in the vessel from the amplitude of the oscillation and the viscosity of the liquid.

18. The method of claim 10, further comprising outputting the indication of the level of boil for control of the heat to a network interface unit of a cooktop, the network interface unit being configured to control the cooktop to control the heat to which the liquid is subjected.
